(19) United States
(12) Patent Application Publication
(10) Pub. No.: US 2015/0375312 A1
(43) Pub. Date: Dec. 31, 2015

(54) BROACH AND METHOD FOR BROACHING SLOTS FOR PARTS SUCH AS TURBINE ROTOR DISKS OR TURBOMACHINE COMPRESSOR DISKS

(71) Applicant: TURBOMECA, Bordes (FR)

(72) Inventors: Sebastien Mandrile, Le Thoronet (FR); Gilles Cazenave-Larroche, Idron (FR); Cyril Vernault, Boeil-Bezing (FR); Gilles Dessein, Garderes (FR); Jean Denape, Lons (FR); Jean-Yves Paris, Oursbelille (FR)

(73) Assignee: TURBOMECA, Bordes (FR)

(21) Appl. No.: 14/764,894

(22) PCT Filed: Jan. 27, 2014
(86) PCT No.: PCT/FR2014/050144

§ 371 Date: Jul. 30, 2015

(30) Foreign Application Priority Data
Feb. 1, 2013 (FR) 1350893

(51) Int. Cl. B23D 43/02; B23D 37/12

(52) U.S. Cl. CPC B23D 43/02; B23D 37/12; B23D 2043/025

(57) ABSTRACT

The invention relates to the broaching of at least one slot (3) in a part such as a turbine rotor disk (4) or a turbomachine compressor disk, said slot (3) being machined by means of a broach (1) inclined at a broaching angle (a). Said broach (1) has an inter-tooth pitch (P) that is a sub-multiple of the length to be broached (L).

### GENERAL TECHNICAL FIELD AND PRIOR ART

The present invention relates to broaching of slots for parts such as turbine rotor discs or turbomachine compressor discs.

It applies especially to broaching of slots of “fir-tree sections” or “bulbs” type for rotor discs or turboengine compressors or aircraft turboprop.

In classical terms, a turboengine or aircraft turboprop comprises a compressor part and a rotary turbine. This turbine in turn comprises a rotor disc which has peripheral attachments (slots in the form of “fir tree sections” or “bulbs”) which are distributed over its circumference and which take up and hold the feet of the blades of said turbine. Some compressor discs also comprise such attachments.

These attachments are generally machined by broaching.

For this reason, as illustrated in FIG. 1A, several passes in a slot 3 to be machined are made using a set of broaches 1.

In the case of slots 3 as “fir tree sections” or in the form of “bulbs” on the periphery of a rotor disc 4 of a turbomachine turbine or a compressor disc, the broaching is often done at a specific inclination (broaching angle α in FIG. 1A). Due to this, for a given broach 1 to be advanced into the slot 3 for machining, the teeth 2 of this broach 1 (spaced at a given pitch P) exert on the walls of the slot 3 in formation alternative forces due to the entry and exit of the teeth in this slot 3.

These alternative forces (arrows F1, F2, F3 in FIG. 1A) produce variation in the direction of forces applied to the broach 1 (resulting arrow F), as illustrated in FIG. 1B. The result is deforming of the broached slot.

This problem is particularly exacerbated in the case of small-sized parts.

An aim of the invention is to resolve this problem.

Many general multicriterion methods of optimisation of broaching tools have already been proposed.

In general, manufacturers of broaches are prohibited from using sub multiple pitches of the thickness to be broached. In the most current cases where the parts to be broached are stacked, use of a sub-multiple pitch of the thickness to be broached is likely to generate substantial deformations on the parts. In general, this rule is also applied in the event where a single part is broached.

The article by Ozturk, O. & Budak, ‘Modeling of broaching process for improved tool design’. Proceedings IEMCE'03, Washington, D.C., Nov. 16-21 2003, p. 1-11 has already proposed using broaching tools with a sub-multiple pitch of the thickness of the part.

The authors indicate in this article that even with this solution it is extremely difficult to produce a variation in zero force between the entry and exit of a part.

Also, this article does not focus on the problems of inclined broaching.

### GENERAL PRESENTATION OF THE INVENTION

An aim of the invention is especially to reduce the variation in cutting forces and reduce deforming of slots.

For this purpose, a broaching process is proposed of at least one slot in a part such as a turbine rotor disc or a turbomachine compressor disc, said slot being machined by means of an inclined broach with a broaching angle relative to the part. Said broach has an inter-tooth pitch as a sub-multiple of the length to be broached.

So, given the difference between the thickness of the part to be broached and the length to be broached which is due to inclination of the broaching, the inter-tooth pitch of the broach is optimised so as to minimise deforming of the slots.

A broach is also proposed for executing this process.

### PRESENTATION OF FIGURES

Other characteristics and advantages of the invention will emerge from the following description which is purely illustrative and non-limiting, and must be considered with respect to the appended figures, in which:

FIGS. 1A and 1B schematically illustrate the broaching of a slot and the variation in cutting forces during descent of the broaching tool according to the known state of the art;

FIG. 2 illustrates in side view a rotor disc and a machining broach of a slot of type “fir tree sections” at the periphery of this disc;

FIG. 3 is a detailed view of FIG. 2;

FIG. 4 is a detailed view which illustrates a tooth of the broach of FIGS. 2 and 3 in a slot machined on the rotor disc;

FIGS. 5A and 5B illustrate slot broaching according to a possible embodiment of the invention, as well as the variation in cutting forces during descent of the broaching tool, FIG. 5A being a view similar to that of FIG. 1, along line A-A of FIG. 4.

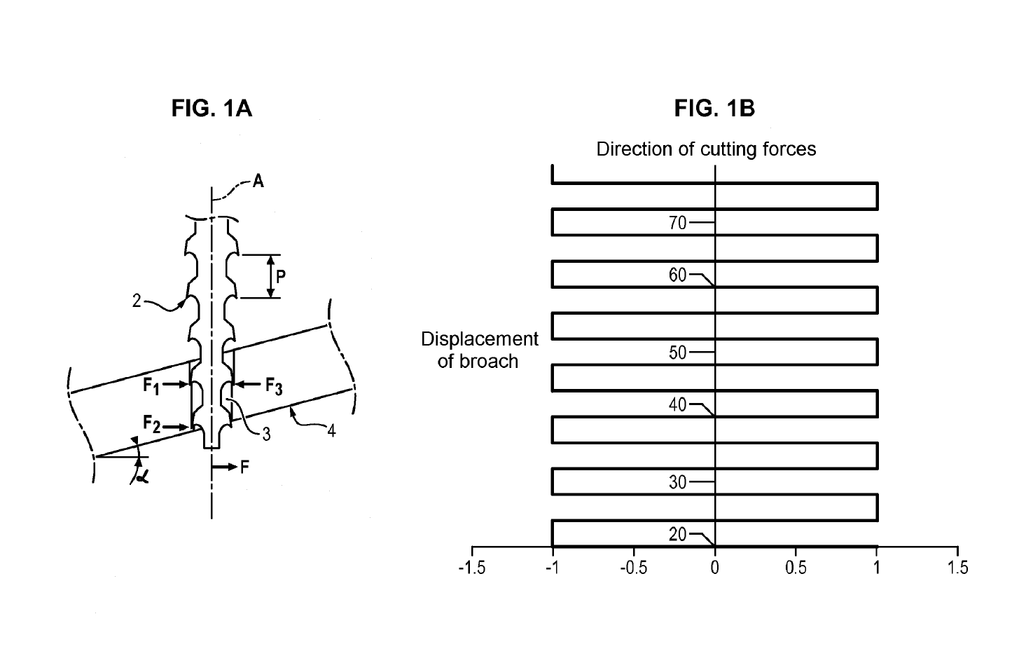

### EXEMPLARY EMBODIMENTS

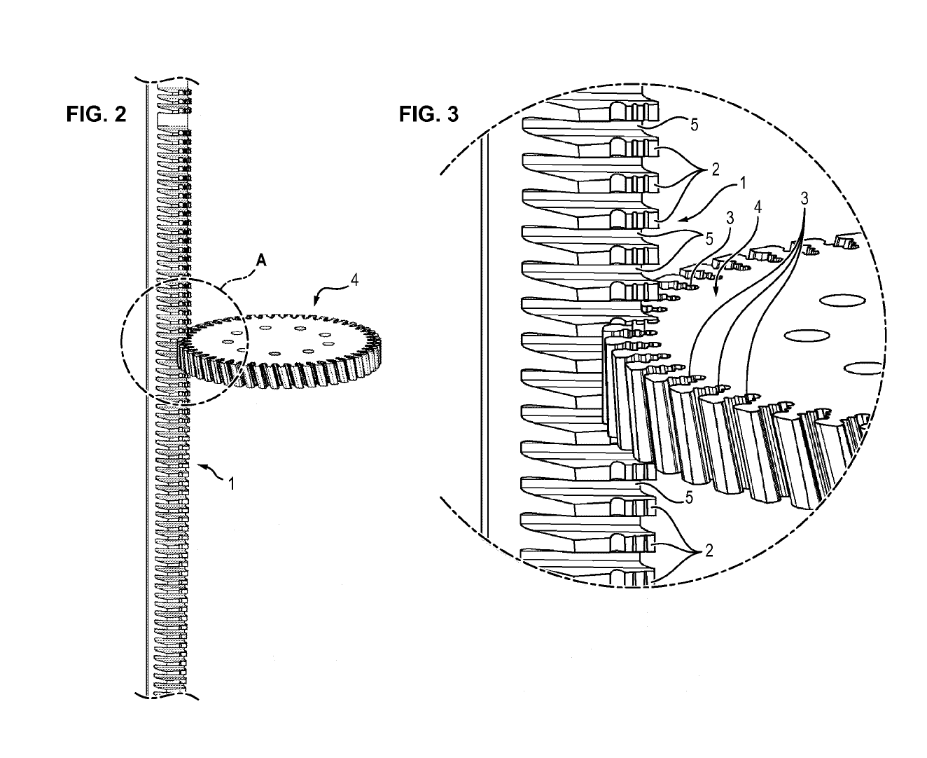

FIGS. 2 to 4 illustrate a rotor disc 4 comprising a plurality of slots 3, and a broach 1 utilised for machining the slots 3. The slots 3 in this case are in the form of “fir tree sections”, with other forms of attachment slots being possible of course (forms of “bulbs” for example).

The broach 1 comprises a plurality of teeth 2. Two successive teeth are separated in pairs by a core 5, the empty space between the core and the apex of the tooth constituting the chip chamber.

The machining it executes is inclined (broaching angle α), such that the thickness Ep of the part to be broached constituted by the rotor disc 4 is different to the length to be broached L.

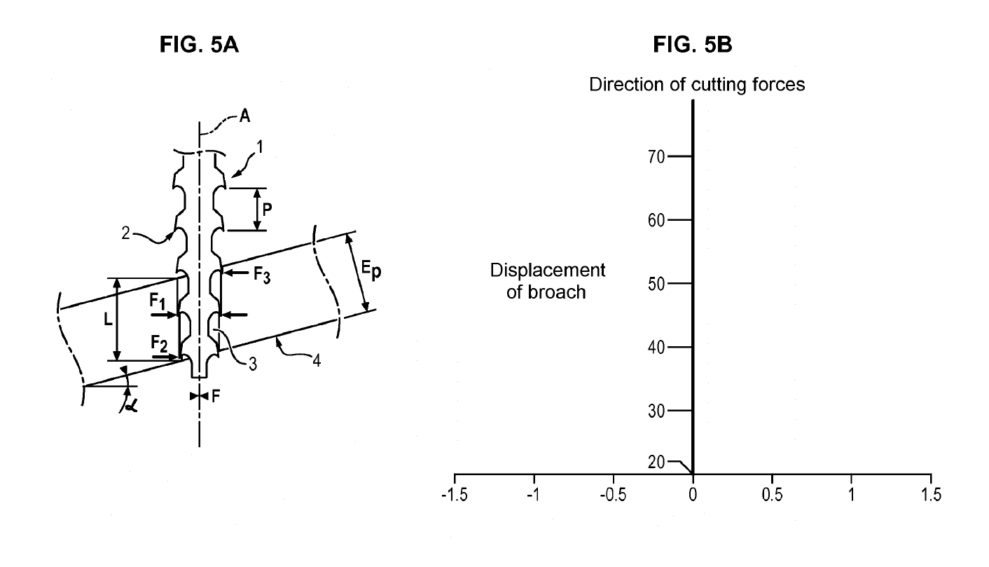

As illustrated in FIG. 5A, the proposed broach utilises a broach pitch P as a sub-multiple of the length to be broached L.

In this way, a tooth 2 enters the slot 3 in formation at the periphery of the machined part (rotor disc 4) at the moment when another tooth 2 exits from it.

The forces (arrows F1 to F4 in FIG. 5A) of the cutting teeth 2 engaged with the walls of the machined slot 3 are balanced on either side of the slot 3. The variation in cutting forces (resulting F) is therefore limited and the alternative component of the forces is eliminated.

This principle is illustrated by FIG. 5B which represents the differential in forces of cuts as a function of displacement.

Given the intervals of tolerancing admitted for the parts machined in this way, the value of the pitch is advantageously selected as equal to:

$$P = \frac{( \frac{{ep}^{max} + {ep}^{min}}{2} )}{( n * cos ( \frac{{α}^{max} + {α}^{min}}{2} ) )}$$

where:
Ep^{max} and Ep^{min} are the maximum and minimum thicknesses of the disc part given the tolerancing,
α^{max} and α^{min} are the maximum and minimum broaching angles given the tolerancing,
n is the preferred number of teeth engaged and being a positive whole number.

It should be noted that the thickness Ep is determined for a given pass of broach 1.

It is calculated from rim to rim between broaching edges on entry and exit of the machined slot 3.

It is likely to vary according to the depth of the slot to which the pass of the broach 1 corresponds, with a rotor disc able to have a variable thickness, especially at the level of its periphery.

The broaching angles α are also determined for each pass. They correspond to the angle between the axis A of descent of the broach 1 and the thickness of the part 4 at the level of the area to be broached.

The broaching which has just been described is particularly interesting in the case of small-sized turbine rotor discs and in particular discs with reduced inter-blade spacing.

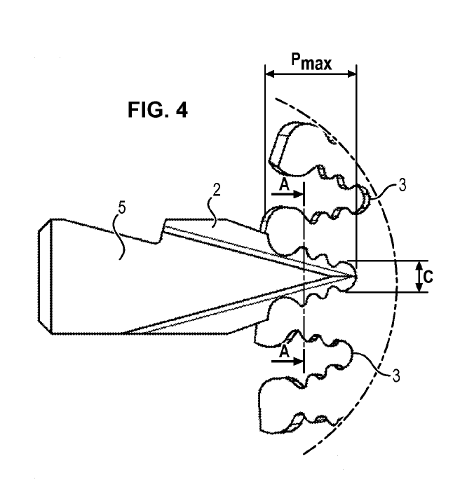

By way of example, this broaching can be used advantageously in the case of turbine discs or compressors with thicknesses less than 20 mm, a maximal slot depth (Pmax in FIG. 4) of the order of 10 to 15 mm and a minimal slot width (c in FIG. 4) of 2 to 3 mm.

The number of teeth n is preferably equal to 2 but could also be equal to 3 or 4.

1-9. (canceled)

10. A broaching process of at least one slot in a part such as a turbine rotor disc or a turbomachine compressor disc, said slot being machined by means of an inclined broach with a broaching angle relative to the part, characterized in that said broach has an inter-tooth pitch (P) as a sub-multiple of the length to be broached (L).

11. The process according to claim 10, characterized in that the inter-tooth broach pitch P is equal to
$$P = \frac{( \frac{{ep}^{max} + {ep}^{min}}{2} )}{( n * cos ( \frac{{α}^{max} + {α}^{min}}{2} ) )}$$
where:
Ep^{max} and Ep^{min} are the maximum and minimum thicknesses of the disc part given the tolerancing,
α^{max} and α^{min} are the maximum and minimum broaching angles given the tolerancing,
n is a positive whole number.

12. The process according to claim 11, characterized in that n is between 1 and 4.

13. The process according to claim 12, characterized in that n is equal to 2.

14. The process according to claim 10, characterized in that a slot is a slot in the form of “fir tree sections” or in the form of “bulbs” machined at the periphery of a turbine rotor disc or a turbomachine compressor disc.

15. The process according to claim 11, characterized in that a slot is a slot in the form of “fir tree sections” or in the form of “bulbs” machined at the periphery of a turbine rotor disc or a turbomachine compressor disc.

16. The process according to claim 12, characterized in that a slot is a slot in the form of “fir tree sections” or in the form of “bulbs” machined at the periphery of a turbine rotor disc or a turbomachine compressor disc.

17. The process according to claim 13, characterized in that a slot is a slot in the form of “fir tree sections” or in the form of “bulbs” machined at the periphery of a turbine rotor disc or a turbomachine compressor disc.

18. A broach for executing a process according to claim 10, comprising a plurality of teeth distributed over its length by being separated in pairs at a given pitch, characterized in that the pitch of the broach is a sub-multiple of the length to be broached.

19. A broach for executing a process according to claim 11, comprising a plurality of teeth distributed over its length by being separated in pairs at a given pitch, characterized in that the pitch of the broach is a sub-multiple of the length to be broached.

20. The broach according to claim 14, characterized in that its pitch is equal to
$$P = \frac{( \frac{{ep}^{max} + {ep}^{min}}{2} )}{( n * cos ( \frac{{α}^{max} + {α}^{min}}{2} ) )}$$
where:
Ep^{max} and Ep^{min} are the maximum and minimum thicknesses of the disc part given the tolerancing,
α^{max} and α^{min} are the maximum and minimum broaching angles given the tolerancing,
n is the preferred number of engaged teeth (being a positive whole number).

21. The broach according to claim 15, characterized in that its pitch is equal to
$$P = \frac{( \frac{{ep}^{max} + {ep}^{min}}{2} )}{( n * cos ( \frac{{α}^{max} + {α}^{min}}{2} ) )}$$
where:
Ep^{max} and Ep^{min} are the maximum and minimum thicknesses of the disc part given the tolerancing,
α^{max} and α^{min} are the maximum and minimum broaching angles given the tolerancing,
n is the preferred number of engaged teeth (being a positive whole number).

22. The broach according to claim 16, characterized in that its pitch is equal to
$$P = \frac{( \frac{{ep}^{max} + {ep}^{min}}{2} )}{( n * cos ( \frac{{α}^{max} + {α}^{min}}{2} ) )}$$
where:
Ep^{max} and Ep^{min} are the maximum and minimum thicknesses of the disc part given the tolerancing,
α^{max} and α^{min} are the maximum and minimum broaching angles given the tolerancing,
n is the preferred number of engaged teeth (being a positive whole number).

23. The broach according to claim 17, characterized in that its pitch is equal to
$$P = \frac{( \frac{{ep}^{max} + {ep}^{min}}{2} )}{( n * cos ( \frac{{α}^{max} + {α}^{min}}{2} ) )}$$
where:
Ep^{max} and Ep^{min} are the maximum and minimum thicknesses of the disc part given the tolerancing,
α^{max} and α^{min} are the maximum and minimum broaching angles given the tolerancing,
n is the preferred number of engaged teeth (being a positive whole number).

24. The broach according to claim 20, characterized in that n is between 1 and 4.

25. The broach according to claim 21, characterized in that n is between 1 and 4.

26. The broach according to claim 22, characterized in that n is between 1 and 4.

27. The broach according to claim 23, characterized in that n is between 1 and 4.

28. The broach according to claim 20, characterized in that n is equal to 2.

29. The broach according to claim 21, characterized in that n is equal to 2.
